(19) United States
(12) Patent Application Publication
(10) Pub. No.: US 2026/0222509 A1
(43) Pub. Date: Jul. 30, 2026

(54) INFORMATION PROCESSING SYSTEM, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Yasushi UJIGAWA, Kanagawa (JP)

(73) Assignee: FUJIFILM Business Innovation Corp., Tokyo (JP)

(21) Appl. No.: 19/309,987

(22) Filed: Aug. 26, 2025

(30) Foreign Application Priority Data
Jan. 28, 2025 (JP) 2025-012439

(51) Int. Cl. H04N 1/387; H04N 1/00; H04N 1/21

(52) U.S. Cl. CPC H04N 1/387; H04N 1/00803; H04N 1/2104; H04N 2201/0081

(57) ABSTRACT

An information processing system includes a processor configured to: when images that a reading unit has read include a blank page, store image information in a state where the blank page has been included; form, based on the image information that has been stored, the images including the blank page on recording media; and transmit image information in a state where the blank page has been removed from the image information that has been stored to a transmission destination.

### CROSS-REFERENCE TO RELATED APPLICATIONS

This application is based on and claims priority under 35 USC 119 from Japanese Patent Application No. 2025-012439 filed January 28, 2025.

### Background

### i. Technical Field

The present disclosure relates to an information processing system, a non-transitory computer readable medium, and an information processing method.

### ii. Related Art

Japanese Unexamined Patent Application Publication No. 2012-147114 discloses an image forming apparatus that executes an image processing job including image data corresponding to each of pages. The image forming apparatus includes a detector and a controller. The detector detects a blank page among the pages in pieces of the image data. The controller removes, when the detector has detected a blank page and a predetermined condition for removing the blank page is satisfied, the image data of the blank page that has been detected and then executes the image processing job and, when the predetermined condition is not satisfied, executes the image processing job without removing the image data of the blank page that has been detected.

Japanese Unexamined Patent Application Publication No. 2018-113539 discloses an image processing apparatus capable of executing a plurality of processes with a single operation. The image forming apparatus includes a reader, a plurality of outputters, a converter, a storage, and a determiner. The reader reads an image. The plurality of outputters output the image that the reader has read. The converter converts first data of the image that the reader has read into second data that is to be outputted through a process to be executed and that is compatible with an output format of the outputters. The storage stores data. The determiner determines a type of a process to be executed. Furthermore, the determiner causes, when it is determined that processes to be executed in response to a single operation are a plurality of processes, the storage to store the first data of the image, which has been acquired as a result of the reading of the reader, which is regarded as a common process in the plurality of processes. The converter directly converts, when a process to be executed in response to a single operation is a solo process, the first data of the image, which the reader has read, into the second data. Furthermore, the converter utilizes, when processes to be executed in response to a single operation are a plurality of processes and the first data has been stored in the storage, the first data stored in the storage to perform conversion into the second data compatible with the output format of the outputters for each of the processes to be executed.

### SUMMARY

As the information processing system, a conceivable information processing systems is as described below. In the information processing system, a processor stores, when images that a reading unit has read include a blank page, image information in a state where the blank page has been included. Furthermore, the processor forms, based on the image information that has been stored, the images on recording media and transmits the image information that has been stored to a transmission destination as is.

Since the image information in the state where the blank page has been included is transmitted to the transmission destination, in this configuration, a volume of the information to be transmitted may easily increase.

Aspects of non-limiting embodiments of the present disclosure relate to reduction of a volume of information to be transmitted, compared with a case where a processor stores image information in a state where a blank page has been included and transmits the image information that has been stored to a transmission destination as is.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor, in which the processor is configured to store, when images that a reading unit has read include a blank page, image information in a state where the blank page has been included, form, based on the image information that has been stored, the images including the blank page on recording media, and transmit image information in a state where the blank page has been removed from the image information that has been stored to a transmission destination.

### BRIEF DESCRIPTION OF THE DRAWINGS

Exemplary embodiments of the present disclosure will be described in detail based on the following figures, wherein:

FIG. 1 is a schematic diagram illustrating an information processing system according to a first exemplary embodiment;

FIG. 2 is a block diagram illustrating an example of a hardware configuration of an information processing apparatus according to the first exemplary embodiment;

FIG. 3 is a block diagram illustrating an example of a functional configuration of the information processing apparatus according to the first exemplary embodiment;

FIG. 4 is a flowchart illustrating an example of a blank page processing flow according to the first exemplary embodiment;

FIG. 5 is a diagram illustrating removal processing for removing a blank page, which is executed in the information processing system according to the first exemplary embodiment;

FIG. 6 is a flowchart illustrating an example of the blank page processing flow according to a second exemplary embodiment;

FIG. 7 is a flowchart illustrating an example of the blank page processing flow according to a third exemplary embodiment;

FIG. 8 is a flowchart illustrating an example of first blank page processing in the blank page processing flow according to the third exemplary embodiment; and

FIG. 9 is a flowchart illustrating an example of second blank page processing in the blank page processing flow according to the third exemplary embodiment.

### DETAILED DESCRIPTION

Examples of exemplary embodiments of the present disclosure will now be described herein with reference to the accompanying drawings.

### First Exemplary Embodiment

### Information Processing System 10

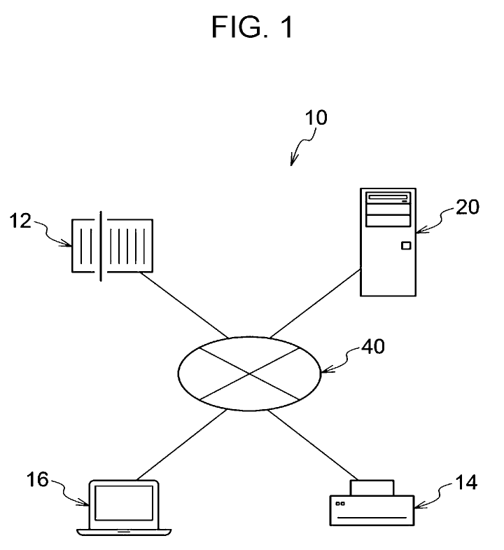

An information processing system 10 according to a present exemplary embodiment will now be described herein. FIG. 1 is a schematic diagram illustrating the information processing system 10 according to the present exemplary embodiment.

As illustrated in FIG. 1, the information processing system 10 according to the present exemplary embodiment includes an image reading apparatus 12, an image forming apparatus 14, a receiving apparatus 16, and an information processing apparatus 20. The image reading apparatus 12, the image forming apparatus 14, the receiving apparatus 16, and the information processing apparatus 20 are coupled to each other via a network 40 such as the Internet. The image reading apparatus 12, the image forming apparatus 14, the receiving apparatus 16, and the information processing apparatus 20 are capable of transmitting and receiving various types of information including image information of images that the image reading apparatus 12 reads to and from each other via the network 40.

Note that the information processing system 10 may include other apparatuses than the image reading apparatus 12, the image forming apparatus 14, the receiving apparatus 16, and the information processing apparatus 20. A plurality of apparatuses configuring the information processing system 10, including the other apparatuses, are coupled to each other via the network 40.

### Image Reading Apparatus 12

The image reading apparatus 12 is an apparatus that reads images of a reading target such as documents. The image reading apparatus 12 includes, for example, a light source, a photoelectric conversion element, and an optical system including a mirror and a lens. The image reading apparatus 12 reads, for example, images of a reading target as described below. That is, in the image reading apparatus 12, the light source emits light to one surface of the reading target. The optical system allows reflection light that the reading target has reflected to form an image on the photoelectric conversion element. The photoelectric conversion element converts the image that the light has formed into an electrical signal to acquire image information. The photoelectric conversion element is, for example, an image sensor such as one of a charge coupled device (CCD) and a complementary metal oxide semiconductor (CMOS).

Note that a user places the reading target on a placement part, for example. Allowing the reading target placed on the placement part to be irradiated with light from above or to be irradiated with light that has passed through the placement part from below makes it possible to achieve reading. In addition, the image reading apparatus 12 may read an image from a reading target being conveyed.

In addition, the image reading apparatus 12 may have another function. Such an image reading apparatus as described above may be, for example, a multifunction machine having a plurality of functions including a copy function, a print function, a fax function, and a reading function. In addition, the image reading apparatus may be, for example, a fax apparatus having a fax function and a reading function. The information processing system 10 may include a plurality of the image reading apparatuses 12.

### Image Forming Apparatus 14

The image forming apparatus 14 is an apparatus that forms images on recording media such as sheets. The image forming apparatus 14 may be, for example, one of an inkjet type image forming apparatus that uses ink to form images on recording media and an electrophotographic type image forming apparatus that uses toner to form images on recording media.

In the inkjet type image forming apparatus, for example, a discharging unit discharges ink droplets onto recording media to form images on the recording media. The inkjet type image forming apparatus may allow the discharging unit to discharge ink droplets onto a transfer body and allow the transfer body to transfer the ink droplets onto recording media to form images on the recording media.

In the electrophotographic type image forming apparatus, for example, processes for charging, exposure, development, transfer, and fixing are performed to form images on recording media. The electrophotographic type image forming apparatus may perform the processes for charging, exposure, development, and transfer to form images on a transfer body, allow the transfer body to transfer the images onto recording media, and fix the images on the recording media to form the images on the recording media.

Note that the image forming apparatus is not limited to one of the inkjet type image forming apparatus described above and the electrophotographic type image forming apparatus described above, as an example, and one of various types of image forming apparatuses may be used.

In addition, the image forming apparatus 14 may have another function. Such an image forming apparatus as described above may be, for example, a multifunction machine having a plurality of functions including a copy function, a print function, a fax function, and a reading function. The information processing system 10 may include a plurality of the image forming apparatuses 14.

### Receiving Apparatus 16

The receiving apparatus 16 is an apparatus that receives image information. In the present exemplary embodiment, the receiving apparatus 16 receives image information that the information processing apparatus 20 transmits. The receiving apparatus 16 is achieved by using, for example, a terminal device such as a computer or a smartphone. The information processing system 10 may include a plurality of the receiving apparatuses 16.

### Information Processing Apparatus 20

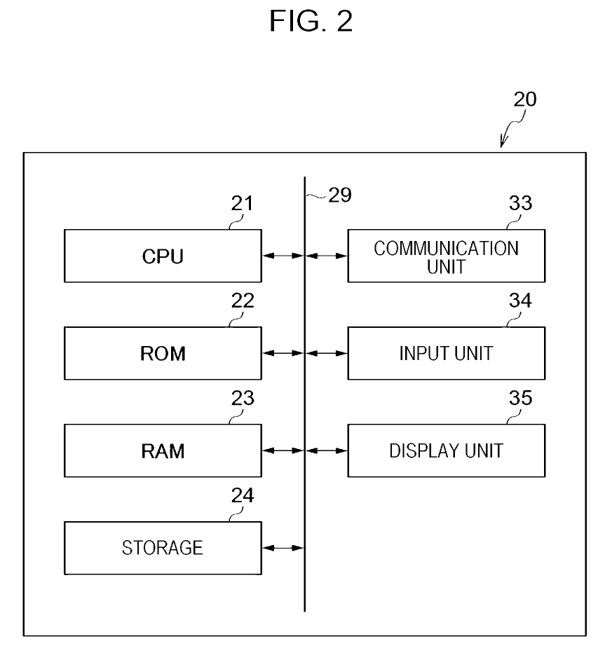

The information processing apparatus 20 functions as a computer, and includes, as illustrated in FIG. 2, a central processing unit (CPU) 21, a read only memory (ROM) 22, a random access memory (RAM) 23, a storage 24, a communication unit 33, an input unit 34, and a display unit 35.

The CPU 21, the ROM 22, the RAM 23, the storage 24, the communication unit 33, the input unit 34, and the display unit 35 are coupled to each other via a coupling line 29. Note that, as an example of the information processing apparatus 20, a general-purpose computer machine such as a server computer and personal computers may be applied. In addition, a configuration of the information processing apparatus 20 is not limited to a configuration solely including the information processing apparatus 20, and may be a configuration including a plurality of the information processing apparatuses 20. Therefore, processes that the information processing apparatus 20 executes may be executed in the plurality of information processing apparatuses 20.

The communication unit 33 is a communication interface and is a component for communicating with other apparatuses. Specifically, the communication unit 33 communicates with other apparatuses through communication lines including the network 40 using at least either a wired scheme or a wireless scheme. The other apparatuses may be, for example, apparatuses including the image reading apparatus 12, the image forming apparatus 14, and the receiving apparatus 16 described above.

The input unit 34 is a component to which the user inputs an instruction. Specifically, the input unit 34 includes, for example, input keys (for example, a keyboard, a mouse, and operation buttons) with which the user performs an input operation. The user is an example of a user.

The display unit 35 displays presentation information to be presented to the user to notify the user of the presentation information. The display unit 35 includes, for example, a liquid crystal display or an organic electroluminescence (EL) display. The display unit 35 is capable of displaying a screen that varies in type.

Note that the display unit 35 may function as the input unit 34. In this case, the input unit includes, for example, a resistive-film or electrostatic-capacity type touch panel on which the user performs a touch operation and to which the user inputs an instruction.

The CPU 21 is a central arithmetic processing unit that executes a program that varies in type, including an information processing program, and controls each component. The ROM 22 stores programs that vary in type, including the information processing program, and data that varies in type. The RAM 23 serves as a working region for temporarily storing a program or data. The storage 24 stores programs that vary in type and data that varies in type. The storage 24 to be used may be, for example, a storage medium to and from which it is possible to write and delete information. The storage medium may be, for example, a non-volatile memory such as a flash memory. Note that the storage 24 to be used may be a volatile memory. In addition, the information processing program may be stored in the storage 24.

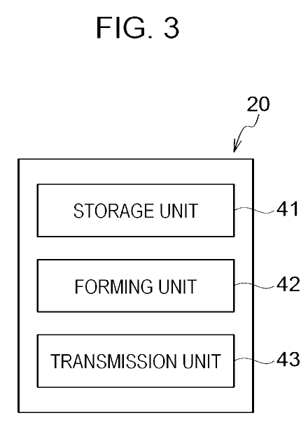

In the information processing apparatus 20, the CPU 21 reads each of the programs that vary in type, including the information processing program, from the ROM 22 or the storage 24 and use the RAM 23 as the working region to execute the program. As the CPU 21 executes the information processing program, the functions that vary in type are achieved. A functional configuration achieved through cooperation of the CPU 21 serving as a hardware resource and the information processing program serving as a software resource will now be described herein. FIG. 3 is a block diagram illustrating an example of the functional configuration of the information processing apparatus 20 according to the present exemplary embodiment.

In the information processing apparatus 20, the CPU 21 executes the information processing program to function as a storage unit 41, a forming unit 42, and a transmission unit 43, as illustrated in FIG. 3.

The storage unit 41 stores, when read images that the image reading apparatus 12 has read include a blank page, image information in a state where the blank page has been removed and position information indicating a position where the blank page has been included in the read images. Note that the image reading apparatus 12 is an example of a reading unit.

The forming unit 42 forms, based on the image information and the position information stored in the storage unit 41, the images including a blank page on recording media. Specifically, the forming unit 42 adds, based on image information of a blank page, which has been prepared in advance, and the position information, an image of the blank page at the position, and forms the images including the blank page on recording media.

The forming unit 42 may execute, based on the position information, idle feeding for conveyance without accompanying formation of images to form the images including the blank page on the recording media. Furthermore, the forming unit 42 may discharge, when an image is to be formed on one surface of one of the recording media and another surface is to be left blank, the one of the recording media to a discharge unit without conveying the one of the recording media to a reversing path for reversing the one of the recording media after the image is formed on the one surface of the one of the recording media.

The transmission unit 43 transmits the image information stored in the storage unit 41 to the receiving apparatus 16. Note that the receiving apparatus 16 is an example of a transmission destination.

### Blank Page Processing Flow according to First Exemplary Embodiment

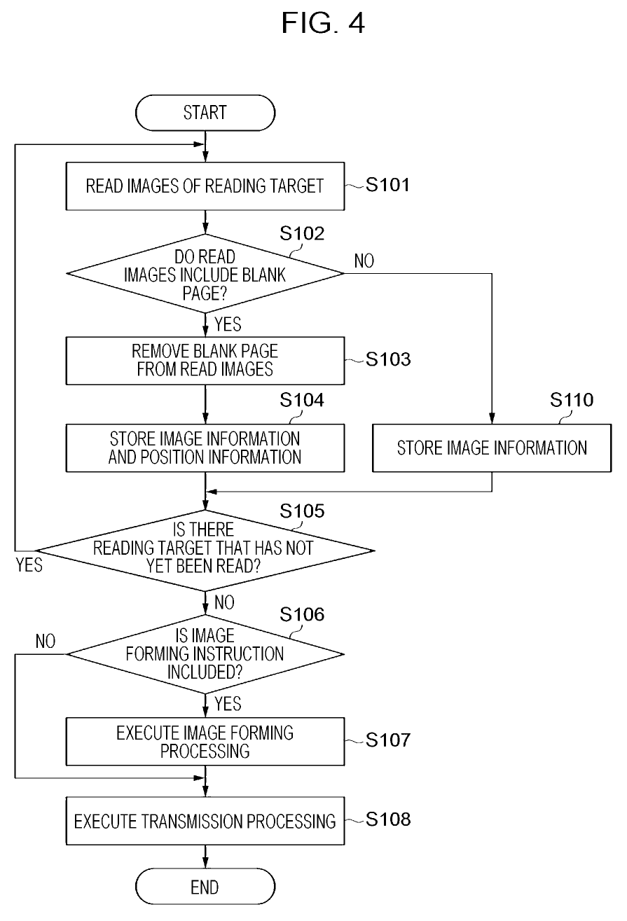

Next, an example of a blank page processing flow that the information processing system 10 executes will now be described herein. FIG. 4 is a flowchart illustrating the example of the blank page processing flow that the information processing system 10 executes. The flow is an example of an information processing method.

Execution of the flow starts when, for example, the CPU 21 acquires a user instruction described below. The user instruction is an instruction for reading images from a reading target and transmitting image information of the images to the receiving apparatus 16. Note that the user instruction may include, for example, an instruction for another purpose than reading of images and transmission of image information (for example, an image forming instruction for forming the images on recording media).

When the flow is started, the CPU 21 causes, at step S101, the image reading apparatus 12 to execute reading of images of a reading target. When reading of images in a plurality of reading units is instructed via the user instruction, the CPU 21 causes the image reading apparatus 12 to execute reading of images of a reading target configuring one of the reading units. Then, the CPU 21 proceeds to step S102.

The CPU 21 determines, at step S102, whether or not the read images that the image reading apparatus 12 has read include a blank page. Note herein that the term "blank page" refers to a blank state with neither a character nor a pattern, for example, and is not necessarily a page colored in white. A blank page is determined, for example, in a unit of one page in read images. Therefore, a certain page in read images is determined as a blank page when an image region in which an image may be formed is in a blank state with neither a character nor a pattern, for example.

The CPU 21 proceeds, when it is determined that the read images include a blank page (step S102: YES), to step S103, and proceeds, when it is determined that the read images include no blank page (step S102: NO), to step S110.

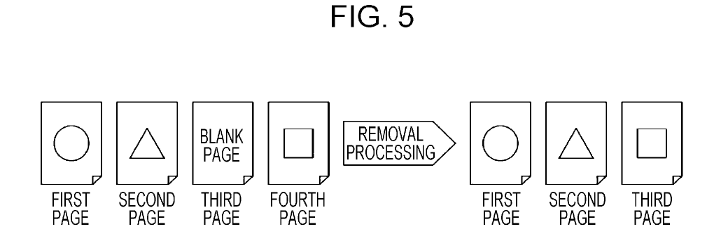

The CPU 21 executes, at step S103, removal processing for removing the blank page from the read images. When a blank page is included in a certain page (a third page in an example illustrated in FIG. 5) in the read images, as illustrated in FIG. 5, for example, the certain page is deleted in the removal processing. Furthermore, pages subsequent to the certain page (fourth and subsequent pages in the example illustrated in FIG. 5) are moved up. Then, the CPU 21 proceeds to step S104.

The CPU 21 stores, at step S104, in the storage 24, for example, image information in a state where the blank page has been removed and position information indicating a position where the blank page was included in the read images. Specifically, the position information is information indicating the certain page (the third page in the example illustrated in FIG. 5) that is the blank page in the read images. The position information is stored in association with the image information. Then, the CPU 21 proceeds to step S105.

The CPU 21 stores, at step S110, in the storage 24, for example, the image information of the images that the image reading apparatus 12 has read. Thus, the image information in a state where no blank page has been included is stored. Then, the CPU 21 proceeds to step S105.

The CPU 21 determines, at step S105, whether or not there is a reading target for which reading of images has not yet been executed. The CPU 21 proceeds, when it is determined that the reading target is present (step S105: YES), to step S101, and proceeds, when it is determined that the reading target is not present (step S105: NO), to step S106.

Thus, when reading of images in a plurality of reading units is instructed via the user instruction, the CPU 21 repeats, for each reading unit, for all the reading units, reading of images (step S101) and storing of image information (step S104 or S110). As a result, pieces of the image information are accumulated in the storage 24.

The CPU 21 determines, at step S106, whether or not the user instruction includes an image forming instruction for forming images. The CPU 21 proceeds, when it is determined that the user instruction has included the image forming instruction (step S106: YES), to step S107, and proceeds, when it is determined that the user instruction has included no image forming instruction (step S106: NO), to step S108.

The CPU 21 causes, at step S107, the image forming apparatus 14 to execute image forming processing for forming images based on the image information stored in the storage 24. Specifically, the CPU 21 causes, when the image information in the state where no blank page has been included has been stored in the storage 24 at step S110, the image forming apparatus 14 to execute the image forming processing for forming the images including no blank page based on the image information. Thus, the image forming apparatus 14 forms the images including no blank page on recording media.

In addition, the CPU 21 causes, when the image information in the state where the blank page has been removed and the position information have been stored in the storage 24 at step S104, the image forming apparatus 14 to execute the image forming processing for forming the images including the blank page based on the image information and the position information. Thus, the image forming apparatus 14 forms the images including the blank page on recording media.

Example modes in which the image forming apparatus 14 forms images including a blank page on recording media include a first forming mode and a second forming mode.

In the first forming mode, for example, image information of a blank page, which has been prepared in advance, is stored in the ROM 22 or the storage 24. The CPU 21 generates, based on the position information stored at step S104, image information in which an image of a blank page is added at the position. When a blank page is included in a certain page (the third page in the example illustrated in FIG. 5) in read images, as illustrated in FIG. 5, for example, image information in which the image of the blank page is added to the certain page is generated. Then, the image forming apparatus 14 forms the images including the blank page on recording media based on the image information.

In the second forming mode, the image forming apparatus 14 executes, based on the position information stored at step S104, for example, idle feeding for conveyance without accompanying formation of images to form the images including the blank page on the recording media. When a blank page is included in a certain page (the third page in the example illustrated in FIG. 5) in the read images, as illustrated in FIG. 5, for example, the controller 11 executes the idle feeding for the certain page to leave the certain page blank.

In the second forming mode, when an image is to be formed on one surface of one of the recording media and another surface is to be left blank, the image forming apparatus 14 may discharge the one of the recording media to the discharge unit without conveying the one of the recording media to the reversing path for reversing the one of the recording media after the image is formed on the one surface of the one of the recording media. Discharging recording media to the discharge unit without conveying the recording media to the reversing path, as described above, makes it possible to execute idle feeding for conveyance without accompanying formation of images to form images including a blank image on recording media.

Then, the CPU 21 proceeds, at step S107, after the image forming apparatus 14 is caused to execute the image forming processing, to step S108.

The CPU 21 transmits, at step S108, the image information stored in the storage 24 to the receiving apparatus 16. The CPU 21 transmits, when the image information in the state where no blank page has been included has been stored in the storage 24 at step S110, the image information in the state where no blank page has been included to the receiving apparatus 16. The CPU 21 transmits, when the image information in the state where the blank page has been removed has been stored in the storage 24 at step S104, the image information in the state where the blank page has been removed to the receiving apparatus 16. Note that, when execution in a plurality of reading units has been instructed, the CPU 21 may perform transmission for each reading unit. Then, the CPU 21 ends the execution of the processing.

### Effects of First Exemplary Embodiment

In the present exemplary embodiment, the CPU 21 stores, when read images that the image reading apparatus 12 has read include a blank page, image information in a state where the blank page has been removed and position information indicating a position where the blank page was included in the read images. Then, the CPU 21 forms, based on the image information and the position information stored in the storage 24, the images including the blank page on recording media. Furthermore, the CPU 21 transmits the image information in the state where the blank page has been removed, which has been stored in the storage 24, to the receiving apparatus 16.

Note herein that, in a configuration (hereinafter referred to as Configuration A) in which the CPU 21 stores image information in a state where a blank page has been removed and forms images on recording media based on the image information that has been stored, misalignment of images with respect to sides of each of recording media may occur when the images are to be formed on both the sides of each of the recording media. Misalignment of images refers to, for example, a state where, when images are to be formed on both sides of one of recording media, one of the images, which should be formed on a back of the one of the recording media, is unintentionally formed on a front of another one of the recording media. In the present exemplary embodiment, where images including a blank page are to be formed on recording media based on the image information and the position information stored in the storage 24, as described above, misalignment of images is suppressed, compared with Configuration A.

In addition, in the first forming mode described above, the CPU 21 adds, based on image information of a blank page, which has been prepared in advance, and the position information, an image of the blank page at the position, and forms the images including the blank page on recording media.

Therefore, even in a system where it is impossible to execute idle feeding for conveyance of recording media without accompanying formation of images, it is possible to form images including a blank page on recording media.

In addition, in the second forming mode described above, the CPU 21 executes, based on the position information, idle feeding for conveyance without accompanying formation of images to form the images including the blank page on the recording media.

Therefore, a period of time required to execute an image forming operation is reduced, compared with a case where it is impossible to form images including a blank page on recording media if formation of images is not accompanied.

In addition, when an image is to be formed on one surface of one of recording media and another surface is to be left blank, in the second forming mode described above, the CPU 21 may discharge the one of the recording media to the discharge unit without conveying the one of the recording media to the reversing path for reversing the one of the recording media after the image is formed on the one surface of the one of the recording media.

With this configuration, even in a case where an image is to be formed on one surface of one of recording media and another surface is to be left blank, it is possible to reduce a period of time required for forming images including a blank page on recording media, compared with a case where the one of the recording media is always conveyed to the reversing path.

### Modification Example of Blank Page Processing Flow According to First Exemplary Embodiment

In the blank page processing flow, when reading of images in a plurality of reading units is instructed via the user instruction, the CPU 21 has repeated, for each reading unit, for all the reading units, reading of images (step S101) and storing of image information (step S104 or S110). Then, although, in the blank page processing flow, the image forming processing (step S107) and transmission of image information (step S108) have been executed after pieces of the image information for all the reading units have been accumulated in the storage 24, the present disclosure is not limited to such an exemplary embodiment.

For example, reading of images (step S101), storing of image information (step S104 or S110), and the image forming processing (step S107) may be executed for each reading unit. In addition, reading of images (step S101), storing of image information (step S104 or S110), the image forming processing (step S107), and transmission of the image information (step S108) may be executed for each reading unit. In addition, the image forming processing (step S107) may be executed while storing of image information (step S104 or S110) is executed.

### Second Exemplary Embodiment

Next, a second exemplary embodiment will now be described herein. Differences from the first exemplary embodiment will now be described herein, and parts identical or similar to corresponding parts in the first exemplary embodiment will be omitted as appropriate.

In the second exemplary embodiment, identical or similar to the first exemplary embodiment, the CPU 21 executes the information processing program in the information processing apparatus 20 to function as the storage unit 41, the forming unit 42, and the transmission unit 43, as illustrated in FIG. 3.

In the second exemplary embodiment, the storage unit 41 stores, when read images that the image reading apparatus 12 has read include a blank page, image information in a state where the blank page has been included.

The forming unit 42 forms the images including the blank page on recording media based on the image information stored in the storage unit 41.

The transmission unit 43 transmits image information in a state where the blank page has been removed from the image information stored in the storage unit 41 to the receiving apparatus 16. The receiving apparatus 16 is an example of a transmission destination.

### Blank Page Processing Flow according to Second Exemplary Embodiment

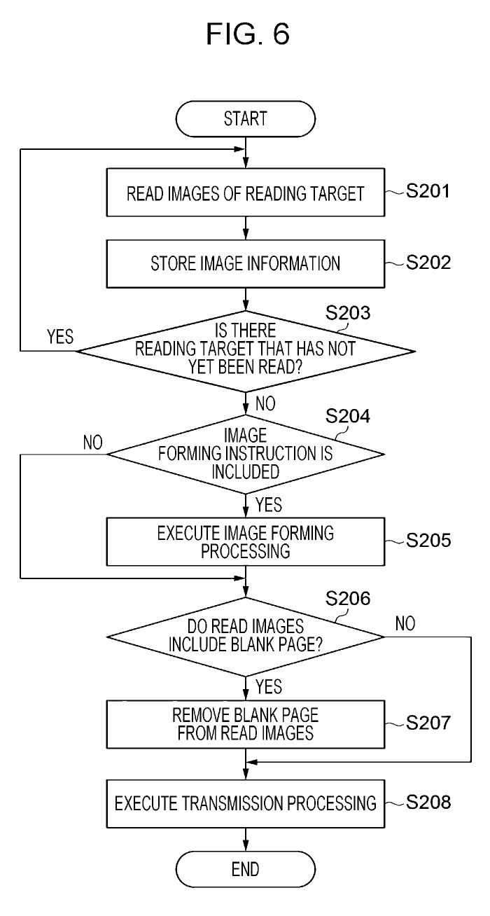

Next, an example of the blank page processing flow according to the second exemplary embodiment will now be described herein. FIG. 6 is a flowchart illustrating the example of the blank page processing flow that the information processing system 10 executes. The flow is an example of the information processing method.

Execution of the flow starts when, for example, the CPU 21 acquires a user instruction described below. The user instruction is an instruction for reading images from a reading target and transmitting image information of the images to the receiving apparatus 16. Note that the user instruction may include, for example, an instruction for another purpose than reading of images and transmission of image information (for example, an image forming instruction for forming the images on recording media).

When the flow is started, the CPU 21 causes, at step S201, the image reading apparatus 12 to execute reading of images of the reading target. When reading of images in a plurality of reading units is instructed via the user instruction, the CPU 21 causes the image reading apparatus 12 to execute reading of images of a reading target configuring one of the reading units. Then, the CPU 21 proceeds to step S202.

The CPU 21 stores, at step S202, in the storage 24, for example, the image information of the images that the image reading apparatus 12 has read. Thus, when the images that the image reading apparatus 12 has read include a blank page, image information in a state where the blank page has been included is stored. When the images that the image reading apparatus 12 has read include no blank page, image information in a state where no blank page has been included is stored. Then, the CPU 21 proceeds to step S203.

The CPU 21 determines, at step S203, whether or not there is a reading target for which reading of images has not yet been executed. The CPU 21 proceeds, when it is determined that the reading target is present (step S203: YES), to step S201, and proceeds, when it is determined that the reading target is not present (step S203: NO), to step S204.

Thus, when reading of images in a plurality of reading units is instructed via the user instruction, the CPU 21 repeats, for each reading unit, for all the reading units, reading of images (step S201) and storing of image information (step S202). As a result, pieces of the image information are accumulated in the storage 24.

The CPU 21 determines, at step S204, whether or not the user instruction includes an image forming instruction for forming images. The CPU 21 proceeds, when it is determined that the user instruction has included the image forming instruction (step S204: YES), to step S205, and proceeds, when it is determined that the user instruction has included no image forming instruction (step S204: NO), to step S206.

The CPU 21 causes, at step S205, the image forming apparatus 14 to execute the image forming processing for forming images based on the image information stored in the storage 24. Specifically, the CPU 21 causes, when the image information in the state where the blank page has been included has been stored in the storage 24 at step S202, the image forming apparatus 14 to execute the image forming processing for forming the images including the blank page based on the image information. Thus, the image forming apparatus 14 forms the images including the blank page on recording media. In addition, the CPU 21 causes, when the image information in the state where no blank page has been included has been stored in the storage 24 at step S202, the image forming apparatus 14 to execute the image forming processing for forming the images including no blank page based on the image information. Thus, the image forming apparatus 14 forms the images including no blank page on recording media. Then, the CPU 21 proceeds to step S206.

The CPU 21 determines, at step S206, whether or not the read images that the image reading apparatus 12 has read include a blank page. The CPU 21 proceeds, when it is determined that the read images include a blank page (step S206: YES), to step S207, and proceeds, when it is determined that the read images include no blank page (step S206: NO), to step S208.

The CPU 21 executes, at step S207, removal processing (see FIG. 5) for removing the blank page from the read images. Then, the CPU 21 proceeds to step S208.

The CPU 21 transmits, at step S208, the image information in the state where the blank page has been removed or the image information in the state where no blank page has been included to the receiving apparatus 16. Note that, when execution in a plurality of reading units has been instructed, the CPU 21 may perform transmission for each reading unit. Then, the CPU 21 ends the execution of the processing.

### Effects of Second Exemplary Embodiment

In the present exemplary embodiment, the CPU 21 stores, when images that the image reading apparatus 12 has read include a blank page, image information in a state where the blank page has been included (step S202). The CPU 21 forms, based on the image information stored in the storage 24, the images including the blank page on recording media (step S205). In addition, the CPU 21 transmits image information in a state where the blank page has been removed from the image information stored in the storage 24 to the receiving apparatus 16 (steps S207 and S208).

Therefore, a volume of information to be transmitted is reduced, compared with a case where the CPU 21 stores image information in a state where a blank page has been included and transmits the image information that has been stored as is to the receiving apparatus 16.

### Modification Example of Blank Page Processing Flow According to Second Exemplary Embodiment

In the blank page processing flow, when reading of images in a plurality of reading units is instructed via the user instruction, the CPU 21 has repeated, for each reading unit, for all the reading units, reading of images (step S201) and storing of image information (step S202). Then, although, in the blank page processing flow, the image forming processing (step S205) and transmission of image information (step S208) have been executed after pieces of the image information for all the reading units have been accumulated in the storage 24, the present disclosure is not limited to such an exemplary embodiment.

For example, reading of images (step S201), storing of image information (step S202), and the image forming processing (step S205) may be executed for each reading unit. In addition, reading of images (step S201), storing of image information (step S202), the image forming processing (step S205), and transmission of image information (step S208) may also be executed. In addition, the image forming processing (step S205) may be executed while storing of image information (step S202) is executed.

### Blank Page Processing Flow according to Third Exemplary Embodiment

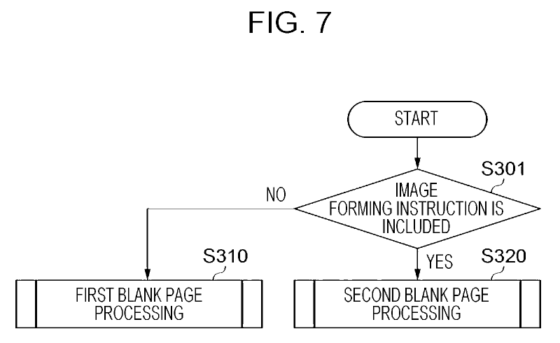

Next, an example of the blank page processing flow according to a third exemplary embodiment will now be described herein. FIGS. 7, 8, and 9 are flowcharts illustrating the example of the blank page processing flow that the information processing system 10 executes. The flow is an example of the information processing method.

Execution of the flow starts when, for example, the CPU 21 acquires a user instruction described below. The user instruction is an instruction for reading images from a reading target and transmitting image information of the images to the receiving apparatus 16. Note that the user instruction may include, for example, an instruction for another purpose than reading of images and transmission of image information (for example, an image forming instruction for forming the images on recording media).

The CPU 21 determines, at step S301, when the flow is started, as illustrated in FIG. 7, whether or not the user instruction includes an image forming instruction for forming images. The CPU 21 executes, when it is determined that the user instruction has included no image forming instruction (step S301: NO), the first blank page processing (step S310), and executes, when it is determined that the user instruction has included the image forming instruction (step S301: YES), the second blank page processing (step S320).

### First Blank Page Processing Step S310

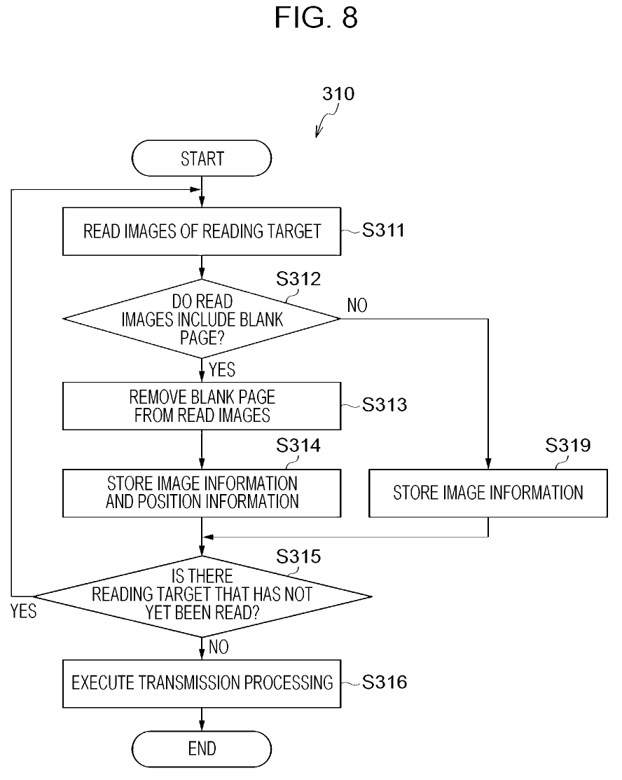

As illustrated in FIG. 8, the CPU 21 causes, at step S311, the image reading apparatus 12 to execute reading of images of a reading target. When reading of images in a plurality of reading units is instructed via the user instruction, the CPU 21 causes the image reading apparatus 12 to execute reading of images of a reading target configuring one of the reading units. Then, the CPU 21 proceeds to step S312.

The CPU 21 determines, at step S312, whether or not the read images that the image reading apparatus 12 has read include a blank page. The CPU 21 proceeds, when it is determined that the read images include a blank page (step S312: YES), to step S313, and proceeds, when it is determined that the read images include no blank page (step S312: NO), to step S319.

The CPU 21 executes, at step S313, the removal processing (see FIG. 5) for removing the blank page from the read images. Then, the CPU 21 proceeds to step S314.

The CPU 21 stores, at step S314, in the storage 24, for example, image information in a state where the blank page has been removed and position information indicating a position where the blank page was included in the read images. Then, the CPU 21 proceeds to step S315.

The CPU 21 stores, at step S319, in the storage 24, for example, image information of the images that the image reading apparatus 12 has read. Thus, the image information in a state where no blank page has been included is stored. Then, the CPU 21 proceeds to step S315.

The CPU 21 determines, at step S315, whether or not there is a reading target for which reading of images has not yet been executed. The CPU 21 proceeds, when it is determined that the reading target is present (step S315: YES), to step S311, and proceeds, when it is determined that the reading target is not present (step S315: NO), to step S316.

Thus, when reading of images in a plurality of reading units is instructed via the user instruction, the CPU 21 repeats, for each reading unit, for all the reading units, reading of images (step S311) and storing of image information (step S314 or S319). As a result, pieces of the image information are accumulated in the storage 24.

The CPU 21 transmits, at step S316, the image information stored in the storage 24 to the receiving apparatus 16. The CPU 21 transmits, when the image information in the state where no blank page has been included has been stored in the storage 24 at step S319, the image information in the state where no blank page has been included to the receiving apparatus 16. The CPU 21 transmits, when the image information in the state where the blank page has been removed has been stored in the storage 24 at step S314, the image information in the state where the blank page has been removed to the receiving apparatus 16. Note that, when execution in a plurality of reading units has been instructed, the CPU 21 may perform transmission for each reading unit. Then, the CPU 21 ends the execution of the processing.

### Modification Example of First Blank Page Processing

In the first blank page processing, when reading of images in a plurality of reading units is instructed via the user instruction, the CPU 21 has repeated, for each reading unit, for all the reading units, reading of images (step S311) and storing of image information (step S314 or S319). Then, although, in the first blank page processing, transmission of image information (step S316) has been executed after pieces of the image information for all the reading units have been accumulated in the storage 24, the present disclosure is not limited to such an exemplary embodiment.

For example, reading of images (step S311), storing of image information (step S314 or S319), and transmission of image information (step S316) may be executed for each reading unit.

### Second Blank Page Processing Step S320

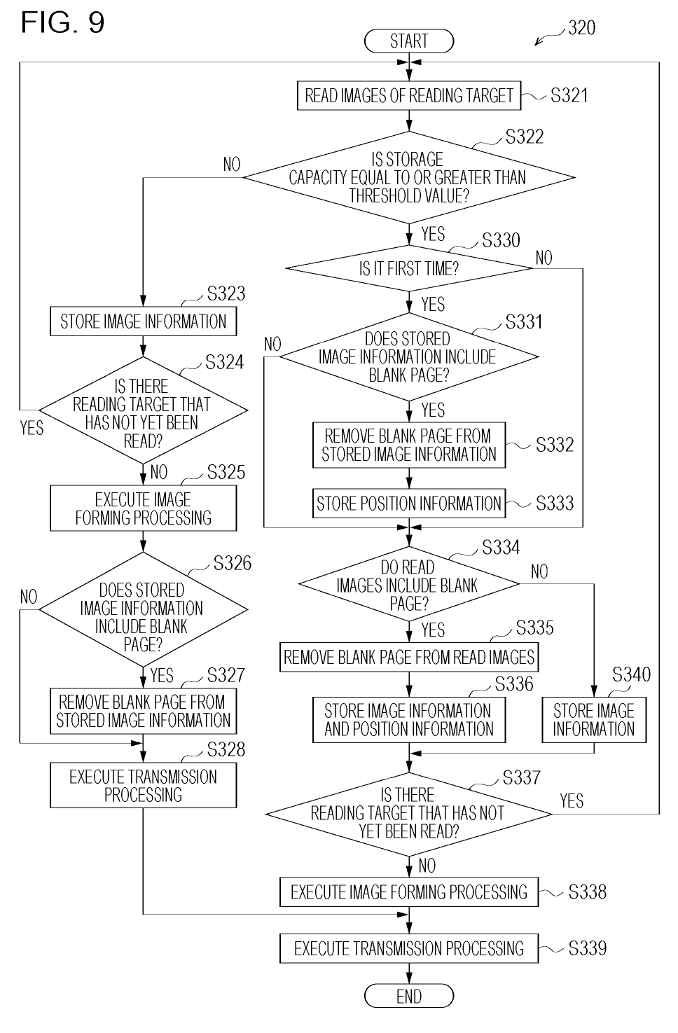

As illustrated in FIG. 9, the CPU 21 causes, at step S321, the image reading apparatus 12 to execute reading of images of a reading target. When reading of images in a plurality of reading units is instructed via the user instruction, the CPU 21 causes the image reading apparatus 12 to execute reading of images of a reading target configuring one of the reading units. Then, the CPU 21 proceeds to step S322.

The CPU 21 determines, at step S322, whether or not a storage capacity for information in the storage 24 is equal to or greater than a predetermined threshold value. The CPU 21 proceeds, when it is determined that the storage capacity for information in the storage 24 is smaller than the predetermined threshold value (step S322: NO), to step S323, and proceeds, when it is determined that the storage capacity for image information in the storage 24 is equal to or greater than the predetermined threshold value (step S322: YES), to step S330.

Note herein that the threshold value is set to be smaller than a maximum value of the storage capacity in the storage 24. Specifically, to make it possible to store the image information of the images that have been read at step S321, for example, the threshold value is set to be equal to or smaller than a value acquired by subtracting a "volume of the image information" from a "maximum value of the storage capacity". Since the "volume of image information" varies depending on a reading target serving as a reading unit, the threshold value may be changed based on a volume of a piece of information of each image that the image reading apparatus 12 reads.

For example, it is possible that the threshold value be a value that is acquired, when the volume of a piece of information is predicted, for each reading of an image, based on an image size of a reading target or whether or not the image is a color or monochrome image, by subtracting the "volume of the piece of information" from the "maximum value of the storage capacity".

The CPU 21 stores, at step S323, in the storage 24, for example, image information of the images that the image reading apparatus 12 has read. Thus, when the images that the image reading apparatus 12 has read include a blank page, image information in a state where the blank page has been included is stored. When the images that the image reading apparatus 12 has read include no blank page, image information in a state where no blank page has been included is stored. Then, the CPU 21 proceeds to step S324.

The CPU 21 determines, at step S324, whether or not there is a reading target for which reading of images has not yet been executed. The CPU 21 proceeds, when it is determined that the reading target is present (step S324: YES), to step S321, and proceeds, when it is determined that the reading target is not present (step S324: NO), to step S325.

The CPU 21 causes, at step S325, the image forming apparatus 14 to execute the image forming processing for forming images based on the image information stored in the storage 24. Specifically, the CPU 21 causes, when the image information in the state where the blank page has been included has been stored in the storage 24 at step S323, the image forming apparatus 14 to execute the image forming processing for forming the images including the blank page based on the image information. Thus, the image forming apparatus 14 forms the images including the blank page on recording media. In addition, the CPU 21 causes, when the image information in the state where no blank page has been included has been stored in the storage 24 at step S323, the image forming apparatus 14 to execute the image forming processing for forming the images including no blank page based on the image information. Thus, the image forming apparatus 14 forms the images including no blank page on recording media. Then, the CPU 21 proceeds to step S326.

The CPU 21 determines, at step S326, whether or not the stored image information stored in the storage 24 includes a blank page. The CPU 21 proceeds, when it is determined that the stored image information includes a blank page (step S326: YES), to step S327, and proceeds, when it is determined that the stored image information includes no blank page (step S326: NO), to step S328.

The CPU 21 executes, at step S327, the removal processing (see FIG. 5) for removing the blank page from the stored image information. Then, the CPU 21 proceeds to step S328.

The CPU 21 transmits, at step S328, the image information in the state where the blank page has been removed or the image information in the state where no blank page has been included to the receiving apparatus 16. Note that, when execution in a plurality of reading units has been instructed, the CPU 21 may perform transmission for each reading unit. Then, the CPU 21 ends the execution of the processing.

The CPU 21 determines, at step S330, whether or not it is a first time that the storage capacity for information in the storage 24 becomes equal to or greater than the predetermined threshold value. The CPU 21 proceeds, when it is determined that it is the first time that the storage capacity for information in the storage 24 becomes equal to or greater than the predetermined threshold value (step S330: YES), to step S331, and proceeds, when it is determined that it is not the first time that the storage capacity for information in the storage 24 becomes equal to or greater than the predetermined threshold value (step S330: NO), to step S334.

The CPU 21 determines, at step S331, whether or not the stored image information stored in the storage 24 includes a blank page. The CPU 21 proceeds, when it is determined that the stored image information includes a blank page (step S331: YES), to step S332, and proceeds, when it is determined that the stored image information includes no blank page (step S331: NO), to step S334.

The CPU 21 executes, at step S332, the removal processing (see FIG. 5) for removing the blank page from the stored image information. Thus, the stored image information is set in a state where the blank page has been removed, increasing the storage capacity of the storage 24. Then, the CPU 21 proceeds to step S333.

The CPU 21 stores, at step S333, in the storage 24, for example, position information indicating a position where the blank page was included in the stored image information. Specifically, the position information is information indicating a certain page (the third page in the example illustrated in FIG. 5) that is a blank page in the image information. The position information is stored in association with the image information. Then, the CPU 21 proceeds to step S334.

The CPU 21 determines, at step S334, whether or not the read images that the image reading apparatus 12 has read include a blank page. The CPU 21 proceeds, when it is determined that the read images include a blank page (step S334: YES), to step S335, and proceeds, when it is determined that the read images include no blank page (step S334: NO), to step S340.

The CPU 21 executes, at step S335, the removal processing (see FIG. 5) for removing the blank page from the read images. Then, the CPU 21 proceeds to step S336.

The CPU 21 stores, at step S336, in the storage 24, for example, image information in a state where the blank page has been removed and position information indicating a position where the blank page was included in the read images. Then, the CPU 21 proceeds to step S337.

The CPU 21 stores, at step S340, in the storage 24, for example, image information of the images that the image reading apparatus 12 has read. Thus, the image information in a state where no blank page has been included is stored. Then, the CPU 21 proceeds to step S337.

The CPU 21 determines, at step S337, whether or not there is a reading target for which reading of images has not yet been executed. The CPU 21 proceeds, when it is determined that the reading target is present (step S337: YES), to step S321, and proceeds, when it is determined that the reading target is not present (step S337: NO), to step S338.

With the execution of step S337 and step S324 described above, when reading of images in a plurality of reading units is instructed via the user instruction, the CPU 21 repeats, for each reading unit, for all the reading units, reading of images (step S321) and storing of image information (step S323, S336, or S340). That is, each time the image reading apparatus 12 reads images, the CPU 21 stores, in the storage 24, image information of the images, and pieces of the image information are accumulated in the storage 24.

The CPU 21 causes, at step S338, the image forming apparatus 14 to execute the image forming processing for forming images based on the image information stored in the storage 24. Specifically, the CPU 21 causes, when the image information in the state where no blank page has been included has been stored in the storage 24 (steps S323 and S340), the image forming apparatus 14 to execute the image forming processing for forming images including no blank page based on the image information. Thus, the image forming apparatus 14 forms the images including no blank page on recording media.

In addition, the CPU 21 causes, when the image information in the state where the blank page has been removed and the position information have been stored in the storage 24 (steps S332, S333, and S336), the image forming apparatus 14 to execute the image forming processing for forming the images including the blank page based on the image information and the position information. Thus, the image forming apparatus 14 forms the images including the blank page on recording media.

The CPU 21 transmits, at step S339, the image information stored in the storage 24 to the receiving apparatus 16. The CPU 21 transmits, when the image information in the state where no blank page has been included has been stored in the storage 24 at step S110 (steps S323 and S340), the image information in the state where no blank page has been included to the receiving apparatus 16. The CPU 21 transmits, when the image information in the state where the blank page has been removed has been stored in the storage 24 at step S104 (steps S332, S333, and S336), the image information in the state where the blank page has been removed to the receiving apparatus 16. Note that, when execution in a plurality of reading units has been instructed, the CPU 21 may perform transmission for each reading unit. Then, the CPU 21 ends the execution of the processing.

### Effects of Second Blank Page Processing Step S320

In the processing, the CPU 21 stores, when images that the image reading apparatus 12 has read include a blank page, image information in a state where the blank page has been included (step S323). The CPU 21 forms, based on the image information stored in the storage 24, the images including the blank page on recording media (step S325). In addition, the CPU 21 transmits image information in a state where the blank page has been removed from the image information stored in the storage 24 to the receiving apparatus 16 (steps S327 and S328).

Therefore, a volume of information to be transmitted is reduced, compared with a case where the CPU 21 stores image information in a state where a blank page has been included and transmits the image information that has been stored as is to the receiving apparatus 16.

In addition, in the processing, the CPU 21 stores, each time the image reading apparatus 12 reads images (step S321), image information in a state where a blank page has been included (step S323). Then, the CPU 21 removes, when a volume of the image information stored in the storage 24 becomes equal to or greater than the predetermined threshold value (step S322: YES), the blank page from the image information that has been stored (step S332), and sets the image information in a state where the blank page has been removed.

Therefore, it is possible to increase the storage capacity for storing image information, compared with a case where such a state always continues that image information stored in the storage 24 includes a blank page.

In addition, in the processing, the CPU 21 may change the threshold value used at step S322 based on a volume of a piece of information of each image that the image reading apparatus 12 reads. Thus, it is possible to increase the storage capacity for storing image information, compared with a case where the threshold value is constant.

In addition, in the processing, the CPU 21 stores position information indicating a position where the blank page, which has been removed from the image information in the storage 24, was included (step S333). Then, the CPU 21 forms, based on the image information in the state where the blank page has been removed and the position information, the images including the blank page on recording media (step S338).

Therefore, misalignment of images with respect to sides of each of recording media is suppressed, compared with a case where the CPU 21 forms images on recording media based solely on image information in a state where a blank page has been removed.

In addition, the CPU 21 stores, when read images that the image reading apparatus 12 has read include a blank page (step S334: YES) after the image information that has been stored in the storage 24 has been set in a state where a blank page has been removed (step S332), image information in a state where the blank page has been removed from the read images and position information indicating a position where the blank page was included in the read images (step S336). Then, the CPU 21 forms, based on the image information and the position information stored in the storage 24, the images including the blank page on recording media (step S338), and transmits the image information that has been stored to the receiving apparatus 16 (step S339).

Therefore, it is possible to increase the storage capacity for storing image information, compared with a case where the CPU 21 stores, even when images that the image reading apparatus 12 has read include a blank page after the image information that has been stored in the storage 24 has been set in a state where a blank page has been removed, image information in a state where the blank page has been included.

### Modification Examples of Second Blank Page Processing

In the second blank page processing, when reading of images in a plurality of reading units is instructed via the user instruction, the CPU 21 has repeated, for each reading unit, for all the reading units, reading of images (step S321) and storing of image information (step S323, S336, or S340). Then, although, in the second blank page processing, the image forming processing (step S325 or S338) and transmission of image information (step S328 or S339) have been executed after pieces of the image information for all the reading units have been accumulated in the storage 24, the present disclosure is not limited to such an exemplary embodiment.

For example, reading of images (step S321), storing of image information (step S323, S336, or S340), and the image forming processing (step S325 or S338) may be executed for each reading unit. In addition, reading of images (step S321), storing of image information (step S323, S336, or S340), the image forming processing (step S325 or S338), and transmission of image information (step S328 or S339) may be executed for each reading unit. In addition, the image forming processing (step S325 or S338) may be executed while storing of image information (step S323, S336, or S340) is executed.

In addition, in the second blank page processing, the CPU 21 has removed, when a volume of the image information stored in the storage 24 becomes equal to or greater than the predetermined threshold value (step S322: YES), the blank page from the image information that has been stored (step S332), and has set the image information in a state where the blank page has been removed, the present disclosure is not limited to such an exemplary embodiment. For example, the CPU 21 may be configured to allow the image information stored in the storage 24 to always keep a state where a blank page has been included.

In addition, although such a configuration has been illustrated that, in the second blank page processing, the CPU 21 changes the threshold value used at step S322 based on a volume of a piece of information of each image that the image reading apparatus 12 reads, the present disclosure is not limited to such an exemplary embodiment. Such a configuration may be applied that the CPU 21 does not change the threshold value and the threshold value is kept constant.

In addition, although such a configuration has been illustrated that, in the second blank page processing, the CPU 21 forms, based on the image information in the state where the blank page has been removed and the position information, the images including the blank page on recording media (step S338), the present disclosure is not limited to such an exemplary embodiment. For example, the CPU 21 may form images on recording media based solely on image information in a state where a blank page has been removed.

In addition, although, in the second blank page processing, the CPU 21 has stored, when read images that the image reading apparatus 12 has read include a blank page (step S334: YES) after the image information that has been stored in the storage 24 has been set in a state where a blank page has been removed (step S332), the image information in the state where the blank page has been removed from the read images and the position information indicating the position where the blank page was included in the read images (step S336), the present disclosure is not limited to such an exemplary embodiment. For example, the CPU 21 may store, even when images that the image reading apparatus 12 has read include a blank page after the image information that has been stored in the storage 24 has been set to a state where the blank page has been removed, image information including the blank page.

### Other Modification Examples

The present invention is not limited to the exemplary embodiments described above, and it is possible to apply various modifications, changes, and improvements without departing from the spirit of the present invention. For example, some of the modification examples described above may be appropriately combined.

In addition, in the exemplary embodiments described above, the processor refers to a processor in a broad sense, and includes a general-purpose processor (for example, the CPU described above) or a dedicated processor (for example, a graphics processing unit (GPU), an application specific integrated circuit (ASIC), a field programmable gate array (FPGA), or a programmable logic device).

In addition, operations of the processor in the exemplary embodiments described above may be not only operations performed by one processor, but also operations performed, in cooperation with each other, by a plurality of processors that exist at physically distant positions. In addition, the order of the operations of the processor is not limited to the order described in the exemplary embodiments described above, and may be appropriately modified.

Furthermore, the program may be firmware or software such as a microcode. In addition, the program may be, for example, a program module group, and its functions may be implemented by processors configured to implement the respective functions. The program may be a program code or a plurality of code segments stored in one or a plurality of non-transitory computer readable media (for example, a storage medium or another storage). The program may be stored in such a divided manner in a plurality of non-transitory computer readable media that are present in apparatuses physically away from each other. The program code or the code segments may represent a procedure, a function, a sub program, a routine, a subroutine, a module, a software package, a class, or any combination of instructions, data structures, or program statements. The program code or the code segments may be coupled to another code segment or a hardware circuit through transmission and/or reception of information, data, an argument, a parameter, or a piece of content in a memory. In addition, the program according to the present disclosure may be provided as a program product.

### Appendix

### (((1)))

An information processing system comprising a processor configured to: when images that a reading unit has read include a blank page, store image information in a state where the blank page has been included; form, based on the image information that has been stored, the images including the blank page on recording media; and transmit image information in a state where the blank page has been removed from the image information that has been stored to a transmission destination.

### (((2)))

The information processing system according to (((1))), wherein the processor is configured to: store, each time the reading unit reads images, image information in a state where the blank page has been included; and, when a volume of the image information that has been stored becomes equal to or greater than a predetermined threshold value, remove the blank page from the image information that has been stored, and set the image information in a state where the blank page has been removed.

### (((3)))

The information processing system according to (((2))), wherein the processor is configured to change the threshold value based on a volume of a piece of information of each image that the reading unit reads.

### (((4)))

The information processing system according to (((2))) or (((3))), wherein the processor is configured to store position information indicating a position where the blank page that has been removed from the image information that has been stored was included, and form, based on the image information in the state where the blank page has been removed and the position information, the images including the blank page on recording media.

### (((5)))

The information processing system according to any one of (((2))) to (((4))), wherein the processor is configured to: when read images that the reading unit has read include a blank page after the image information that has been stored has been set in a state where the blank page has been removed, store image information in a state where the blank page has been removed from the read images and position information indicating a position where the blank page was included in the read images; form, based on the image information and the position information that have been stored, the images including the blank page on recording media; and transmit the image information that has been stored to a transmission destination.

### (((6)))

An information processing system comprising a processor configured to: when read images that a reading unit has read include a blank page, store image information in a state where the blank page has been removed and position information indicating a position where the blank page was included in the read images; form, based on the image information and the position information that have been stored, the images including the blank page on recording media; and transmit the image information that has been stored to a transmission destination.

### (((7)))

The information processing system according to (((6))), wherein the processor is configured to add, based on image information of a blank page, the image information being prepared in advance, and the position information, an image of the blank page at the position, and form the images including the blank page on the recording media.

### (((8)))

The information processing system according to (((6))) or (((7))), wherein the processor is configured to execute, based on the position information, idle feeding for conveyance without accompanying formation of images to form the images including the blank page on the recording media.

### (((9)))

The information processing system according to any one of (((6))) to (((8))), wherein the processor is configured to discharge, when an image is to be formed on one surface of one of the recording media and another surface is to be left blank, the one of the recording media to a discharge unit without conveying the one of the recording media to a reversing path for reversing the one of the recording media after the image is formed on the one surface of the one of the recording media.

### (((10)))

A program for causing a computer to perform a process for information processing, the process comprising: when images that a reading unit has read include a blank page, storing image information in a state where the blank page has been included; forming, based on the image information that has been stored, the images including the blank page on recording media; and transmitting image information in a state where the blank page has been removed from the image information that has been stored to a transmission destination.

### (((11)))

An information processing method comprising: when images that a reading unit has read include a blank page, storing image information in a state where the blank page has been included; forming, based on the image information that has been stored, the images including the blank page on recording media; and transmitting image information in a state where the blank page has been removed from the image information that has been stored to a transmission destination.

What is claimed is:

1. An information processing system comprising:
a processor configured to:
when images that a reading unit has read include a blank page,
store image information in a state where the blank page has been included,
form, based on the image information that has been stored, the images including the blank page on recording media; and
transmit image information in a state where the blank page has been removed from the image information that has been stored to a transmission destination.

2. The information processing system according to claim 1, wherein the processor is configured to:
store, each time the reading unit reads images, image information in a state where the blank page has been included; and,
when a volume of the image information that has been stored becomes equal to or greater than a predetermined threshold value,
remove the blank page from the image information that has been stored, and set the image information in a state where the blank page has been removed.

3. The information processing system according to claim 2, wherein the processor is configured to:
change the threshold value based on a volume of a piece of information of each image that the reading unit reads.

4. The information processing system according to claim 2, wherein the processor is configured to:
store position information indicating a position where the blank page that has been removed from the image information that has been stored was included; and
form, based on the image information in the state where the blank page has been removed and the position information, the images including the blank page on recording media.

5. The information processing system according to claim 2, wherein the processor is configured to:
when read images that the reading unit has read include a blank page after the image information that has been stored has been set in a state where the blank page has been removed,
store image information in a state where the blank page has been removed from the read images and position information indicating a position where the blank page was included in the read images;
form, based on the image information and the position information that have been stored, the images including the blank page on recording media; and
transmit the image information that has been stored to a transmission destination.

6. An information processing system comprising a processor configured to:
when read images that a reading unit has read include a blank page,
store image information in a state where the blank page has been removed and position information indicating a position where the blank page was included in the read images;
form, based on the image information and the position information that have been stored, the images including the blank page on recording media; and
transmit the image information that has been stored to a transmission destination.

7. The information processing system according to claim 6, wherein the processor is configured to:
add, based on image information of a blank page, the image information being prepared in advance, and the position information, an image of the blank page at the position, and form the images including the blank page on the recording media.

8. The information processing system according to claim 6, wherein the processor is configured to:
execute, based on the position information, idle feeding for conveyance without accompanying formation of images to form the images including the blank page on the recording media.

9. The information processing system according to claim 6, wherein the processor is configured to:
discharge, when an image is to be formed on one surface of one of the recording media and another surface is to be left blank, the one of the recording media to a discharge unit without conveying the one of the recording media to a reversing path for reversing the one of the recording media after the image is formed on the one surface of the one of the recording media.

10. A non-transitory computer readable medium storing a program causing a computer to perform a process for information processing, the process comprising:
when images that a reading unit has read include a blank page,
storing image information in a state where the blank page has been included;
forming, based on the image information that has been stored, the images including the blank page on recording media; and
transmitting image information in a state where the blank page has been removed from the image information that has been stored to a transmission destination.

11. An information processing method comprising:
when images that a reading unit has read include a blank page,
storing image information in a state where the blank page has been included;
forming, based on the image information that has been stored, the images including the blank page on recording media; and
transmitting image information in a state where the blank page has been removed from the image information that has been stored to a transmission destination.
